(19) United States
(12) Patent Application Publication
(10) Pub. No.: US 2010/0199099 A1
(43) Pub. Date: Aug. 5, 2010

(54) User friendly Authentication and Login Method Using Multiple X509 Digital Certificates

(76) Inventor: Junling Wu, San Jose, CA (US)

Correspondence Address: JUNLING WU, 472 AVALANI AVE., SAN JOSE, CA, 95133, US

(21) Appl. No.: 12/366,455

(22) Filed: Feb. 5, 2009

(51) Int. Cl. H04L 9/00

(52) U.S. Cl. 713/182

(57) ABSTRACT

A new login method enables user friendly login process using X.509 digital certificate. A special purpose web page plug-in enables such login capability by plug-and-play to any web site login page. Multifold certificate is composed of multiple certificates with each of them contains different amount of personal information (FIG. 1) suitable for different business purpose. A daemon runs in user's computer to retrieve certificate and communicate with the plug-in on behalf of user. The daemon ensures the mutually agreement between user and web server on the type of certificate to be used during the login process. A password recovery method ensure smooth recovery from lose of password. The security feature allows a user to login from many different computers by transferring the multifold certificate freely. An invariant user identifier is constructed from user's personal data in a particular way (FIG. 2) so that the identifier is the same regardless where and when it is constructed.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

1. Technical Field

The present invention is a new method of login and authentication over network using X.509 digital certificate. It applies the web plug-in and the computer network client-server technologies to achieve a powerful user friendly authentication process. The methods can be used anywhere regardless the network Firewall, NAT or VPN. The present invention can be widely used by all web sites to improve customer experience and to create more online business which require some level of customer's identity.

2. Description of Related Art

User authentication is needed almost every where over network, such as email access, software distribution, online dating, blogs, forums, online banking, etc. In general, companies want to create a user profile before provide services to a customer.

There are various authentication methods available. The username and password, the biometric data, the digital certificate are those examples. While these technologies are available, simplicity is a key fact to make use of them widely. The online services are target to large number of population as well as peoples with different levels of technical skills. To be success, it is a vital for a company to make its process as simple as possible without sacrifice quality

The personal biometric data such as fingerprints and iris scan require specialized equipments to collect the data from a person. These equipments are not generally accessible to normal businesses due to high cost in hardware, software and maintenance. It is impossible to use it widely in the near future.

The digital certificate are widely used today for device authentication over network such as SSH (the Secure Shell ), SSL (Secure Socket Layer) such as HTTPS. The functionality is build into the computer application such as web browser, UNIX, Linux and Windows software distributions. The digital certificates used in such application are actually pertinent to a computer device and not related to a person. It is mainly used for a client to authenticate the server.

Some online transactions use digital certificate as the authentication method. An example of such technology is the SET (Secure Electronic Transaction) known as a protocol for making a credit card account settlement over the Internet. While the digital certificate can be used, it involves complicated programming task for web developers to implement it.

Each digital certificate has a unique private key. This private key is usually stored in a key store which is a file resides in the client computer. The user has to use the particular computer in order to access the key store when needed. A typical user may need use different computers from work, from home, etc. It can not assume that the user always use a same computer. This scenario makes the digital certificate authentication inconvenient to the user. A user without technical knowledge of the digital certificate will find it complicate since it does not provide much visual feedback during the process. The user will be wondering how it works and have no idea what to do if problem comes up. For large population, the technical support will be a burden to web site runners.

The digital certificate is also used for user login for some web sites in a certain way. A user will need to upload the certificate file to the web server by using HTML file uploading function. Because the file transfer is explicitly used in the login, the process is not transparent to the user. The look and feel is different from traditional login process.

Most widely authentication method is the username and password authentication method. This method is easy to implement. Most importantly, it is easy to understand by end users that makes the process smooth.

While the username/password authentication is easy to use, each web site company has its own user database. User needs to establish an account with each of these web sites in order to access the services. Therefore, a typical user has many accounts. The user has to remember many passwords and usernames. Also, the user needs to repeat the similar registration process for each web site. In doing business, companies can not share their databases with each other.

Here is a common login process today. When a user accesses an application from computer network, the user is prompted to enter username and password. The username and password is sent to server. The server looks up its database for the username. Once the username and password match a record in the database, the user is successfully authenticated. This login process is common today. There are many companies provide online services to customers. Each of the services has its own database to maintain user profiles. A user will create username and password for each of the service. It is impossible for a user to keep a username for all his/her accounts. Usually a good username he/she wishes to use may not be accepted because it has been taken by an existing user. She/he has to try many usernames before get a valid one. It ends up that the user has many different usernames and passwords for those services. It is not easy for an ordinary person to remember many different usernames and passwords.

In the other hand, the user information provided during registration can not be easily verified. For example, a user may give any name, gender, date of birth. It would be expensive for a company to verify each user during the registration. Some kinds of online services need accurate personal information. In such a case, the user verification will be necessary. The verification will be a burden either to the company or to the user. In the other hand, the user may walk away from such a verification process because of the tedious and boring task.

It would be desirable that a user can get ride of such burden to remember so many passwords and usernames to access the online services.

It would be desirable that the personal data verification can be done easily and smoothly during user login.

It would be desirable that the service starts immediately for the new user without waiting long time for verification.

### BRIEF SUMMARY OF THE INVENTION

In one embodiment, a package with one or more X.509 digital certificates packed together with private keys into a single file. The certificates and private keys are encrypted within the package as well. In this invention, this certificate package is referred to “multifold” certificate. The certificates within a “multifold” certificate have special relationship. The issuer of the “multifold” certificate can determine their subject unique string from user's personal information. However their relationship can not be discovered by anyone other than the issuer. This relationship is used to establish CRL entries for the “multifold” certificate by the issuer. The “multifold” certificate is a file with many pieces of encrypted items. Since the items are encrypted, it is safe for a user to place, copy or mail it. Optionally, the “multifold” certificate can include issuer's certificate which should not be encrypted.

In one embodiment, a system for generating “multifold” certificate is provided. The system is a web server operable to receive requests from individuals who require “multifold” certificate. The system collects and verifies person information from the applicant. It then generates the “multifold” certificate to the applicant. The user receives the “multifold” certificate and stores it in his/her computer or any other kind of storage device.

In one embodiment, daemon software is provided. The daemon software is always running in user's computer. The daemon software is responsible to retrieve and send certificate on behalf of the certificate owner.

In one embodiment, a method for user authentication is provided. The method includes a web plug-in embedded in HTML page. The web plug-in acts as a middleman between daemon software and web server. It passes data back and forth between daemon and web server. The web server obtains user's X.509 through the helps from middleman. The middleman arrangement is especially important to overcome the firewall and NAT barrier which prevent web server from initiating connection to user computer.

These features will be more clearly understood from the following descriptions.

### BRIEF DESCRIPTION OF THE DRAWINGS

The present invention will now be described, by way of example only, with reference to certain embodiments shown in the attached Figures in which:

FIG. 1 is a table describe what personal data is contained in each certification level

FIG. 2 illustrates how the certificate identities are constructed

FIG. 3 illustrates the process to generate a 3-fold certificate

FIG. 4A format of request message (send by web server to request certificate from client)

FIG. 4B format of response message (send by client to web server)

FIG. 5 is a block diagram to illustrate the typical activities involved a use case

FIG. 6 illustrates how the password recovery information is build.

### DETAILED DESCRIPTION OF THE INVENTION

The present invention provides a new method for user registration and login. It provides a solution to eliminate the limitations of login and registration method used today. By adopting the new method of this invention it will extent the playground of online business and services.

The certificate level is implemented as a critical extension of X.509 certificate. The “critical extension” is defined in RFC3280. The “multifold” certificate is a bundle of multiple X.509 certificates each has a different certificate level. The level is simply used to model the amount of personal information encoded in each certificate.

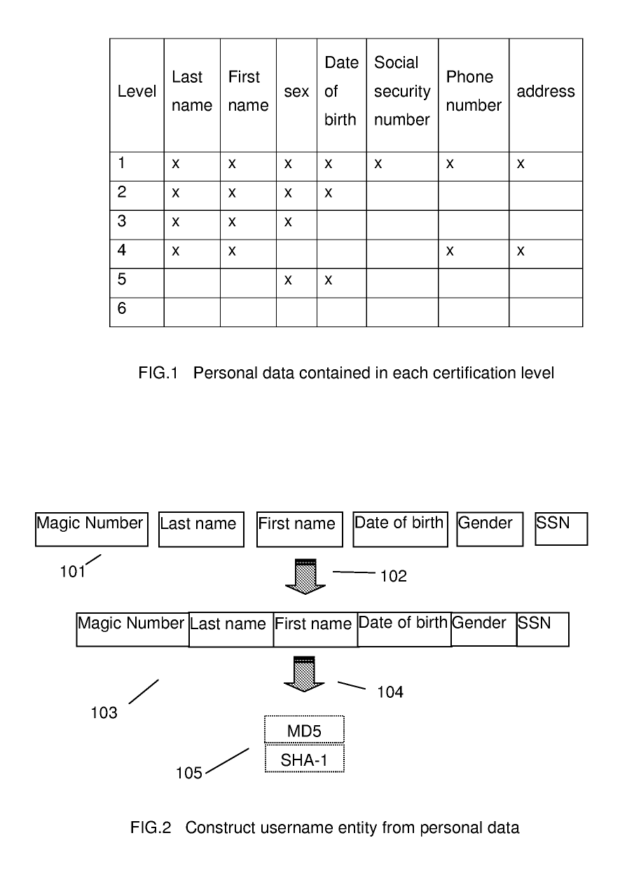

The table in FIG. 1 describes the personal data for each level.

The level 1 is the highest in confidential. The level 6 is the least in confidential. When a request comes to a owner and ask for owner's level 1 certificate, the owner will know what personal data will be send out. The owner will be very caution to send level 1 certificate as it contains all the confidential data.

A level 6 certificate contains no confidential data. Although the level 6 certificate does not contain any personal data, it does have a unique certificate identifier. Level 6 is very useful. For example, an online survey can ask for level 6 certificate. Since the Level 6 has a unique user identifier, it can make sure that one response per user.

The level is clearly defines what information the certificate contains. The use will be clearly about what information is to be sent to the web server.

A “multifold” certificate contains two or more individual certificates. Each certificate is a standard X.509 v3 digital certificate defined in RFC3280. The X.509 v3 certificate supports extension fields. This invention uses the extension fields to record subject identity. The subject identity is derived from user's personal information. Since personal information is not changed often over time. For example, the date of birth, the gender, the social security number, the first name and last name are such information. The information provided by user can be verified through Credit Card Company. FIG. 1 describes the formation of the identity. In FIG. 1, There are six parameters (101). Which are concatenated into string (102). The order of those input parameters must be arranged in a pre-defined order. The order is pre-defined, it must not be changed. The concatenated string (102) is used to generate a MD5 message digest and a SHA-1 hash value (103). These two values are used as identity for the subject. Since the identity is derived from personal information, the user always gets the same identity string for the certificate no mater when he/she requests for it. It is not like the serial number which is randomly assigned.

In one embodiment, a “multifold” certificate is issued to a user. The “multifold” certificate is a package of multiple X.509 digital certificates. Each certificate within the package conforms to X.509 v3 format. The v3 format supports critical extension fields as well as non-critical extension fields. This invention uses the extension fields to store unique subject identifiers, legal terms, and release type. The unique subject identifiers are derived from user's personal information. The unique information is used to construct the unique identifiers as illustrated in FIG. 2. It should be understood that the tokens can be any personal data as long as they can uniquely identify a person. The tokens and the order they appear in the string must be well defined by the issuer. The “Magic Number” in FIG. 2 is needed to distinguish the subject identifiers between certificates within a “multifold” certificate. The “Magic Number” is kept secret to the issuer. There should be 6 different “Magic Number” if the “multifold” certificate supports 6 levels. Therefore, each certificate has the unique identifier which is different from each other, even though they are all derived from the same personal information in the package. The subject's unique identifier is a MD5 message digits and SHA-2 hash value, as shown in FIG. 2. The original tokens can not be discovered from MD5 or SHA-2 value. Both SHA-2 and MD5 values are included in to the content of certificate as critical extensions. The format of critical extension is defined in RFC3280. FIG. 2 is an example of the process. In FIG. 2, 101 is the list of tokens which are the personal data chosen for the example. 102 is the string concatenate operation. 103 is the resulted string. 104 is the MD5 and SHA-1 calculation. 105 are the two unique identifiers which will be included as the critical extensions.

More critical extensions can be added to the certificate depends on the application. For example, a legal term of the certificate usage can be added. Another example is the release type of the certificate can be added.

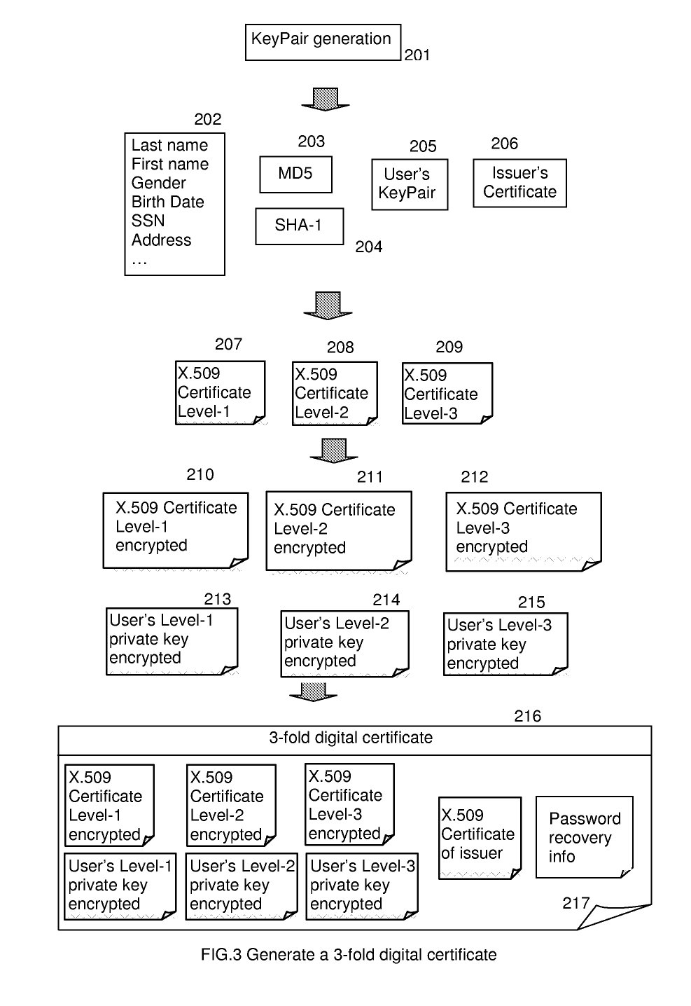

The certificates and their corresponding private keys are encrypted by using PBE (password based encryption) algorithm. User will provide a password while requesting a multifold certificate. The password is required to decrypt the encrypted items within the multifold certificate. User can change the password anytime. The “multifold certificate is a single file. It can be saved anywhere. The user has to keep the password in secret. FIG. 3 illustrates the certificate generation process. FIG. 3 is an example of the process for generating 3-fold certificate. It should be understood that N-fold certificate can be generated in the same way. “N” can be any integer. In FIG. 3, 201 is the key generation using any standard algorithm. The key pair is generated for the user. 202 is the list of personal data to be included in the certificate. 203 and 204 are the unique subject identifiers to be included as critical extensions. These two unique identifiers are assigned to the user and they are unique. 205 is the user key pair used in X.509 certificate generation. 206 is the issuer's certificate to be included in the package. 207,208 and 209 are the generated certificates with different level. Each level has different personal data. They are encrypted further using PBE encryption algorithm (a.k.a. password based encryption). The three resulting encrypted version of the certificates are 210,211 and 212. In addition, the user's private keys are encrypted. 213,214 and 215 are the corresponding encrypted private keys. 216 is the 3-fold certificate. In 216, there are 7 components zipped into a single file which is the resulted “3-fold” certificate.

The certificate subject or owner (referred as “owner” in the following discussion) will save the multifold certificate in the computer. The content of the “multifold” certificate is encrypted. The data within the multifold certificate is protected by password.

Only one “multifold” X.509 certificate is needed to access all online services around the world. The multifold certificate is stored in the owner's computer. The user needs to remember the password and the file name. Since the multifold certificate file is stored in user's computer, the filename can be any string at user's choice. The user will not need to go through the registration process in order to access a web site. The web site will ask for the certificate and verify the certificate with certificate issuer's public key. Once the certificate is verified, the web site can save user's certificate and start server the user. This feature will allow the service provider smoothly and quickly to enroll new customers.

To use the current invention, a web service provider need to import the issuer's public key or certificate. The issuer's public key or certificate is made public and distributed via the same methods used today over internet. A specific web plug-in is needed. The web plug-in can be written in any computer language. For example, a Java can be used. The web plug-in is embedded in the web site login page. The web plug-in acts like a middleman to pass data between user computer and server. The plug-in can be plugged into any web page and is configurable. Here is the standard HTML code example. Where the MiddlemanApplet.class is the Java Applet class which does the work. The “level” parameter configure the login use the level 1 certificate. The “request_url” parameter is the server side JSP page to create request message. The “response_url” is the server side JSP page to decode and parse the user certificate response.

<form>

<input value=“Login1”onclick=“eval(document.middleman.login( ));” type=“button”>

</form>

<applet archive=“./authen.zip”code=“authen.SupermanApplet.class”

name=“middleman”height=“0”width=“0”>
<param name=“level”value=“1”>
<param name=“request_url”value=“gen_request.action”>
<param name=“response_url”value=“parse_response.action”>

</applet>

The above HTML will display a button in the web page. The applet is configurable through the <param> inner tag. The above example has three <param>. The “level”tells which certificate level it asks for from user. The “request_url” is the JSP page which generates request message. The “response_url”is the JSP page which parses the user response message for certificate information. The button is associated to the applet via the “onclick” event handler. Whenever the use click the button, the login( ) method of the applet will be invoked.

The JSP page for generating request has the following lines:

<%@page import=“network.EscLogin”%>

<%@page contentType=“text/plain”%>

<%

String level=request.getParameter(“level”);

EscLogin Ign=new EscLogin( );

Ign.setPassword(“aabbcc1122”);

Ign.setMessage(level);

%>

<%=lgn.getRequestParcel( )%>

The JSP page for parsing the user response message and generating an example output which displays some of the certificate content. For a real web site, the certificate content will be used to retrieve user profile and to redirect user to a useful web page.

<%@page import=“network.EscLogin,java.util.regex.*,java.io.*”%>

<%@page import=“java.security.*,java.security.cert.*,java.util.*”%>

<%@page import=“com.chaosinmotion.asn1.*”%>

<%!

public String decodeStr(byte[ ] bts) throws Exception {
BerInputStream berIn=new BerlnputStream(new ByteArrayInputStream (bts));
BerOctetString octet=new BerOctetString( );
octet.decodeElement(berIn);
return new String(octet.getValue( ));

}

%>
EscLogin Ign=new EscLogin( );
Ign.setPassword(“aabbcc1122”);//server side password hard coded
String str=request.getParameter(“val”);
//Pattern p=Pattern.compile(“ ”);
//Matcher m=p.matcher(str);
//str=m.replaceAll(“+”);
X509Certificate cert=Ign.parseResponseParcel(str);
Principal p=cert.getSubjectDN( );
Set<String>critSet=cert.getCriticalExtensionOlDs( );
String[ ] exts=critSet.toArray(new String[0]);
String[ ] v=new String[exts.length];
for ( int i=0; i<exts.length;i++) {
   v[i]=decodeStr(cert.getExtensionValue(exts[i]));
}

%>

<p>This certificate has <%=exts.length %>critical extensions.

<TABLE border=1>

<TR><TD>Subject Principal<TD>Name<TD><%=p.getName( )%>

<% for ( int i=0;i<exts.length;i++) { %>

<TR><TD>critical Extension <%=i%><TD>OID <%=exts[i]%><TD><%=v[i]%>

<%;}%>

</TABLE>

Where the EscLogin Java class implemets all the business logical. It reads the “level” parameter and generate certificate request for this level.

To use this invention, a user needs to install a specific program in his/her computer. This program is a daemon which runs all the time as long as the computer is up. When a user wish to login to a web site, the web login page embedded with a web plug-in will communicated with the daemon to get user's certificate. The daemon will ask the certificate owner for password. This is the PBE password for decryption. The user can reject the request if he/she want stop. If rejected, the certificate will be not send.

The daemon is a server program. It is running in user's computer and is always up. This daemon listens to designate port for incoming request. The web login page (embedded with a web plug-in) send request to this port. The web plug-in acts like a middleman to do the job for the web server. When the daemon receives the request, it reads the request and verifies the web server's certificate which comes along with the request. It will popup a dialog window displaying with web server's identity and details of the request. The user can then read the information and chose to accept or reject it. A significant advantage of using middleman is to enable the web server to initiate the connection to the daemon running in client machine. Without middleman, this connection is impossible if NAT or Firewall presented. Almost all home computers are using NAT when subscribe to internet provider.

The following code is a working example of the daemon implemented in Java. The two major classes are listed.

The lServer application is running in user's machine. It listen to port “7123”. Whenever a request comes to this port, it create a “Job” thread to process the request.

package network;

import java.net.*;

import java.io.*;

public class lServer {
private int port;
public static void main(String[ ] args) {
   lServer svr=new lServer(7123);
   svr.start( );
}
public lServer(int port) {
   this.port=port;
}
public void start( ) {
   try {
      ServerSocket ss=new ServerSocket(port);
      int i=0;
      while (true) {
         System.out.println(“Listen to port: “+port);
         Socket s=ss.accept( );
         System.out.println(“process:”+i);
         process(s);
      }
   }
   catch(Exception e) {
      e.printStackTrace( );
   }
}
public void process(Socket s) {
   try {
      Thread t=new Job(s.getInputStream( ),s.getOutputStream( ));
      t.start( );
   }
   catch (Exception e) {
      e.printStackTrace( );
   }
}

}

Java code for the “Job” class. The Job class parse the request and invoke the “Dialog”. The Dialog will interact with user to get user name and password and retrieve the certificate from the multifold certificate file.

package network;

import java.awt.Toolkit;

import java.io.*;

import esc_client.*;

import java.util.regex.*;

import javax.xml.parsers.DocumentBuilder;

import javax.xml.parsers.DocumentBuilderFactory;

import org.w3c.dom.Document;

import org.w3c.dom.Element;

import org.w3c.dom.NodeList;

import java.util.regex.*;

public class Job extends Thread {
InputStream in;
OutputStream out;
Pattern pHello=Pattern.compile(“<HELLO/>”);
Pattern pAck=Pattern.compile(“<ACK/>”);
Pattern pNak=Pattern.compile(“<NAK/>”);
Pattern pData=Pattern.compile(“<DATA>(.*)</DATA>”);
Pattern pBye=Pattern.compille(“<BYE/>”);
public Job(InputStream in,OutputStream out) {
   this.in=in;
   this.out=out;
}
public void run( ) {
   try {
      byte[ ] bs=new byte[100];
      int count;
      ByteArrayOutputStream buf=new ByteArrayOutputStream( );
      Matcher m=null;
      String str=null;
      int loop=0;
      while (true) {
         count=in.read(bs,0,100);
         if(count>0) {
         buf.write(bs, 0, count);
         str=new String(buf.toByteArray( ));
         10 log.info(str);
         }
         else if (count<0) {
         break;
         } else {
         continue;
         }
         m=pHello.matcher(str);
         if(m.find( )) {
         out.write(“<ACK/>”.getBytes( ));
         out.flush( );
         buf.reset( );
         continue;
         }
         m=pData.matcher(str);
         if(m.find( )) {
         new Dialog(m.group(1),in,out);
         break;
         }
         m=pBye.matcher(str);
         if(m.find( )) {
         out.write(“<ACK/>”.getBytes( ));
         out.flush( );
         break;
         }
      }
   }
   catch (Exception e) {
      e. printStackTrace( );
   }
}

}

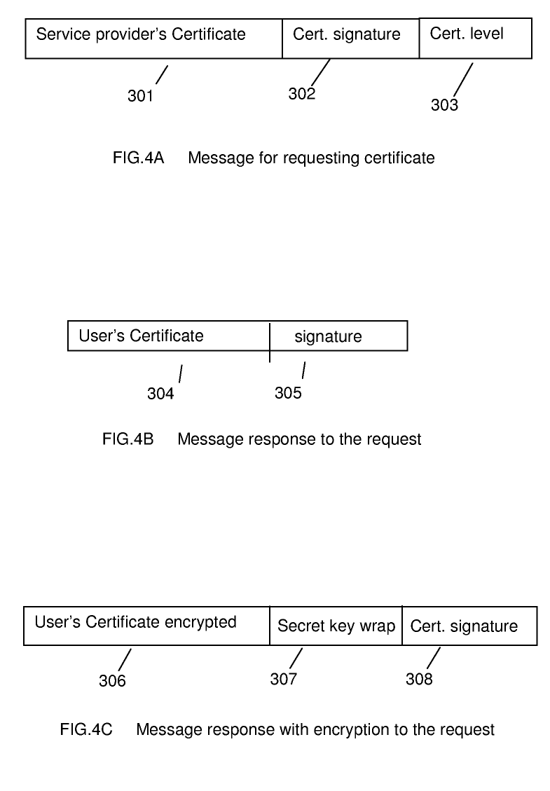

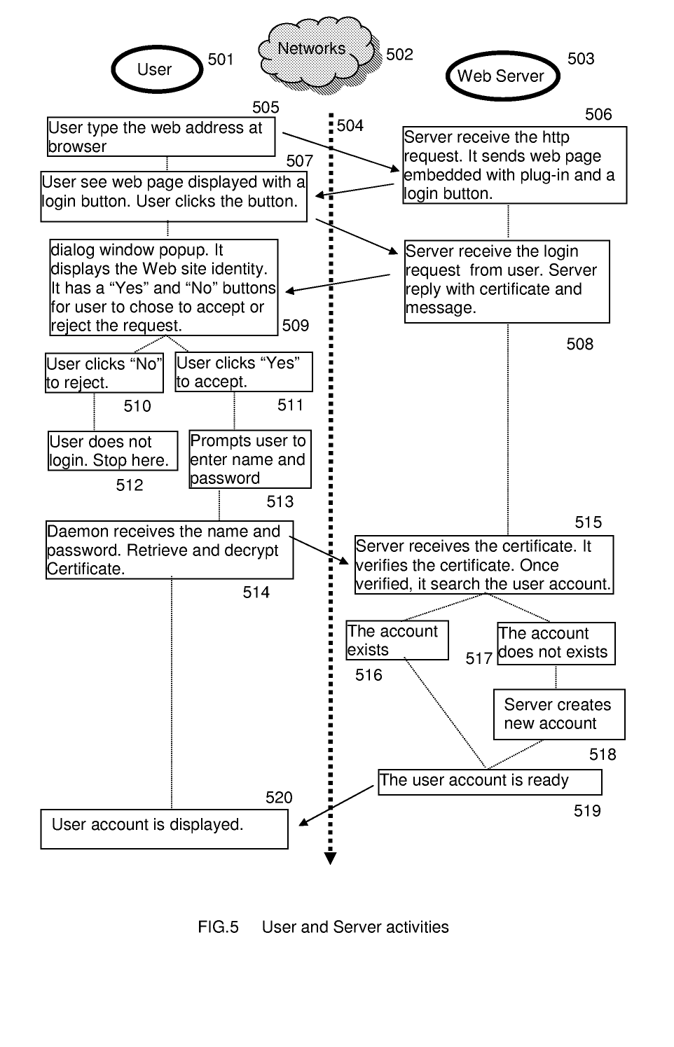

The request and response message are show in FIG. 4. A web server sends a certificate request message to the daemon through the web plug-in which is embedded in the login web page. The message format is illustrated in FIG. 4A. The message includes 301, the web server certificate. It should not be encrypted. 302 is the digital signature of the certificate signed with certificate's corresponding private key. This signature is used by daemon to verify the certificate. Upon receiving the request, the receiver will verify the content of the request. The verification has two parts. The first part is to verify that the certificate is valid. The second part is to verify that the certificate sender has the private key of the certificate. 303 is the certificate level the web server needs from the user. 301 and 302 are encoded with Base64 encoding.

The response messages are shown in FIG. 4B and FIG. 4C. Both formats can be used. FIG. 4B is used when the privacy is not a concern. User does not bother to encrypt the certificate being sent. 304 is the certificate encoded in Base64. 305 is the digital signature of the certificate signed with certificate's corresponding private key. This signature is used by the web server to verify the certificate. Upon receiving the response, the web server will verify the content of the response. The verification has two parts. The first part is to verify that the certificate is valid. The second part is to verify that the certificate sender has the private key of the certificate. FIG. 4C is used when the privacy is a concern. 306 is the certificate encrypted with a random secret key. 306 is encoded in Base64. 307 is the random secret key wrapped with web server's public key. The secret key is needed to decrypt the certificate being sent. Since the secret key is wrapped by web server's public key, the web server's private key is needed to unwrap it. The secret key is used to decrypt the certificate from 306. 308 is the signature calculated from the certificate being sent. It is used by web server to verify the integrity of the certificate being sent.

In an embodiment, a user login to a web server. FIG. 5 illustrates the complete process. 501 is the user computer. It has the daemon running. 502 is the network. 503 is the web server providing the online services. It uses the current invention to authenticate user. The dash vertical line in the middle of the drawing represents the network connecting user computer and web server. 505 the user open the internet browser, enter the web address. 506 the web server receives the http request. It sends the login page to the user. The login page is embedded the web plug-in. 507 the user receive the login page and click the login button on the page. As soon as the user click the login button, the JavaScript/Ajax in the page open a synchronize channel in the background to connect to the web server. 508 the web server sends the request message (see FIG. 4A) to the JavaScript through this channel. The JavaScript invoke the embedded web plug-in and pass to it the request message. The web plug-in in turn sends the request message to the daemon. 509 the daemon receives the request message and popup the dialog. The user sees a dialog window popup. It displays the web server's identity and the certificate it is asking for. 510 the user reject the request by click the “No” button and the login aborted 512. Or, 511 the user can click “Yes” button to accept the request. 513 the dialog prompts user to enter the name and password. The name is the filename of the “multifold” certificate in user's computer. The password is the PBE password with which the daemon needs to decrypt the certificate. 514 the daemon receives the name and password. It retrieves the X.509 certificate from the “multifold” certificate and builds a response message (see FIG. 4B and FIG. 4C). The response message is send to back the web plug-in. The JavaScript in the page can read the response message through the web plug-in API. It then sends the response to the web server via synchronized channel by using the Ajax API. 515 the web server receives the response message and retrieves the certificate. It verifies the certificate by the signature. Once verified, the web server looks up the user's unique identifier in its database. 516 the user's is in the database. It means it is a existing user. In other case, 517 the user can not be found in the database. 518 a new account is created immediately for the user. 519 the user account is ready and the user login is successful. 520 the user is in login state. The service is started.

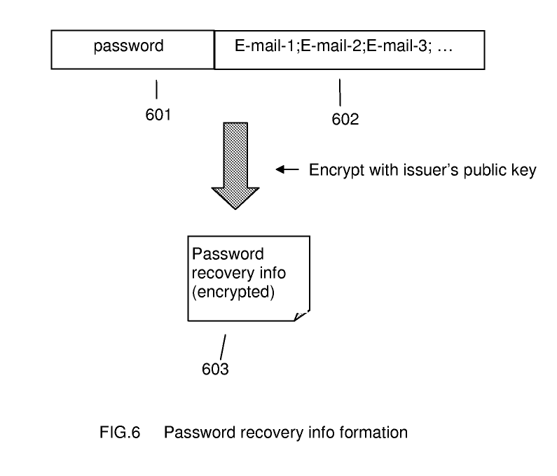

The PBE encrypt algorithm is used in encrypting the content of the multifold certificate file. A user chose a password as a require parameter to the encryption function. The user will need to keep the password in a safe place. The daemon will ask user for the password in order to retrieve the certificate from the multifold certificate file. Without the password, the content can not be decrypted. The password recovery is used when user can not remember the password. This invention provided a specific way to recover the password. Whenever a user creates a new password or changes the existing password to a new password, the new password is encrypted with the issuer's public key. The user's email address is also encrypted along with the password. This scheme is illustrated in FIG. 6. The encrypted password and email address is saved as part of the multifold certificate file (illustrated as 517 in FIG. 5).

If the user needs to recover the password, the user will send this password recovery info to the certificate issuer. The certificate issuer has the private key to decrypt the password and the email address. Once decrypted, the recovered password is send to the email addresses found in the password recovery info.

The current invention claimed is:

1. A multifold certificate package packs multiple certificates and corresponding private keys in one file that has the following characteristics:
a) Each certificate within is encrypted and need a password to decrypt it
b) Each private key within is encrypted and need a password to decrypt it
c) Optionally, the issuer's certificate is packed in the multifold certificate, as illustrated in FIG. 3
d) Each certificate within contains different amount of personal information and marked with a level indicator
e) Each certificate within has a critical extension which carries a user identifier claimed in claim 2
f) The unique string herein is calculated from the personal data and a magic number by using MD5 and SHA1 algorithm, so that the result unique string can not be reversed to original data
g) The magic number herein is solely determined by the level indicator as described in claim 1, c)

2. A unique string which is the one way hash value of the original character string with the following features:
a) The one-way value herein is a calculation from any of the available standard hash algorithms including but not limited to MD5, SHA-1 and SHA-2
b) The original character string herein is a concatenation of several substrings with a space character inserted between any two of them
c) The order of the substrings within the original character string herein is predefined by certificate issuer who creates the multifold certificate claimed in claim 1
d) Each substring herein itself does not contain any space character
e) One of the substrings herein is an arbitrary magic string selected by certificate issuer who creates the multifold certificate claimed in claim 1
f) All the substrings herein except the magic substring are certificate user's personal data
g) The personal data herein includes but not limited to first name, last name, gender, data of birth, address, phone number, SSN, etc.
h) The original character string herein can not discovered from its resulted unique string herein

3. A daemon software running in user's computer listening to a designated port for incoming request for certificate, with the following functions or features:
a) The daemon herein verifies the signature of the incoming request before proceed
b) The daemon herein pops up a dialog window with the following behaviors
c) Dialog window herein displays the identity of the request originator and the level indicator claimed in claim 1
d) Dialog window herein displays a text field for user to enter the multifold certificate file name claimed in claim 1
e) Dialog window herein displays password field for user to enter password claimed in claim 1
f) Dialog window herein provide a choice for user to stop sending certificate
g) Dialog window herein provide a choice for user to confirm to send certificate
h) Upon receiving user's confirmation, the daemon herein retrieves the certificate with the specified level indicator from the multifold certificate claimed in claim 1
i) The daemon packs the certificate in such a way that it encrypt the content with web server's public key and send it to web plug-in claimed in claim 3.

4. A web plug-in embedded in a web page plays the role of middleman to pass back and forth specific messages between web server and daemon claimed in claim 2, and with the following features and functions:
a) The plug-in herein is linked or associated to a particular button or anchor within the web page
b) The plug-in herein is invoked whenever user clicks the particular button or anchor herein
c) when invoked, the plug-in herein sends a http request to the web server to retrieve a request message
d) The request message is composed in such a way that it includes the web server's certificate which can be verified by the daemon claimed in claim 2 and the certificate it is asking for from user
e) Alternatively, if the request message is embedded in the web page, the plug-in herein do not need to retrieve a request message from server
f) The request message herein is including the web server's certificate in order to show its identity to user and can be verified by the daemon claimed in claim 2
g) The request message herein includes the certificate level claimed in claim 1 in order to tell the user which certificate the web server is asking for
h) The plug-in herein pass the request message to the daemon claimed in claim 2
i) The plug-in herein pass the response message from the daemon claimed in claim 2 to web server

5. A password recovery method to recover the password which is needed by the daemon claimed in claim 3 with the following steps:
a) Construct a super string which has two distinct parts
b) The first part herein is the password to be protected and to be recovered
c) The second part herein is a list of email addresses provided by user
d) Encrypt the super string herein with the certificate issuer's public key using any of available algorithm
e) Save the encrypted string as part of the multifold certificate file
f) When a user wish to recovery the password, the user sends this encrypted super string to the certificate issuer who owns the private key for decryption and the decrypted password is send to one or all of the email addresses found in the super string
